(19) United States
(12) Patent Application Publication
(10) Pub. No.: US 2012/0097485 A1
(43) Pub. Date: Apr. 26, 2012

(54) PARKING GARAGE ELEVATOR SYSTEM FOR VEHICLES

(75) Inventor: Fridolin Stutz, Lufingen (CH)

(73) Assignee: SKYLINE PARKING AG, Winterthur (CH)

(21) Appl. No.: 13/380,840

(22) PCT Filed: May 31, 2010
(86) PCT No.: PCT/IB2010/001341

§ 371 Date: Dec. 25, 2011

(30) Foreign Application Priority Data
Jun. 29, 2009 (CH) 01001/09

(51) Int. Cl. E04H 6/28; E04H 6/18; B66B 9/00

(52) U.S. Cl. 187/249

(57) ABSTRACT

The elevator system for vehicles is intended for a parking garage having a central elevator shaft (13) consisting of two semi-circles. Parking areas (14) are arranged around the elevator shaft at different levels. Each area has a central semi-circle shaped inner edge (16) adjoining the elevator shaft (14). The elevators which can be operated independently of each other, are arranged in the elevator shaft. Each elevator platform (1) is supported on an approximately diametric cross beam (17) extending over the elevator shaft (1). The platform (1) extends there from halfway into the elevator shaft (13). The cross beam (17) is mounted and guided on vertical rails (8, 28) outside of the elevator shaft (13). The carrying cables (6) for the cross beam (17) having the platform (19) and for the counterweight (7) are arranged outside of the central elevator shaft (13), above the top parking deck (9).

The present invention relates to an elevator system for vehicles in a multiple floor parking garage. The aim by this system is to lift up and lower quickly and safely the vehicles and furthermore to rotate the elevator platform. An automatic parking garage is yet known from the patent WO2006/039830 which uses a central elevator from which the vehicles are pushed to the parking floors which are radially arranged around the central elevator shaft. The elevator proposed in this document is for a single vehicle. The entire elevator's construction rotates around the vertical axis so that the vehicles can be pushed in different directions to the parking floors. The vehicles to be parked are first measured, for example, by means of a scanner in order to detect the parking gaps existing on the parking garage where the associated robot could place the vehicle in the most space optimized manner. It was found that the contour of a plan view of a car and the maximal height of a vehicle are sufficient for this measurement, i.e. the shadow of the car when the light falls vertically on the floor. When the vehicles are parked in a space optimized manner, taking into account the contour of the plan view, the medium surface required for the parking of one car is only 15 m². It is possible to park vehicles of a maximal length of 5.3 m side by side on an annular disc which outer diameter is only 8.7 m. 16 vehicles with a maximal length of 5.3 m can be arranged on this annular disc. The ground surface for 16 vehicles is (8.72 m)²×π=˜237 m² and one car needs a footprint from ˜15 m². In case of a parking deck height of 1.80 m, the place requirement for 16 vehicles is ˜427 m² and one car needs ˜27 m². Conventional parking garages require a multiple footprint per vehicle compared to the parking garages of the present invention. Dense parking allows to park much more vehicles in a determined parking garage volume and therefore the organization of these parking places requires a higher capacity standard for the elevator which must be able to pick-up, lift up, rotate and push the vehicles on the parking floors and vice versa.

The object of this invention is to realize an improved elevator system for the parking garages equipped with a central elevator shaft; the said elevator system allowing a higher capacity, is simple to manufacture and can be safely operated and the elevator system is able to lift, to lower and rotate the vehicles. Furthermore, this elevator system offers an increased redundancy in a parking garage as regards to the conventional solutions.

This task is solved by an elevator system for vehicles in a in a parking garage of several floors with a central elevator shaft and parking surfaces arranged around the said elevator shaft, each floor having a central and circular inner edge adjacent to the elevator shaft characterized in that two elevators are arranged in the elevator shaft which can be operated independently from one another; each elevator platform being supported on an approximately diametric cross beam extending over the elevator shaft and the platform extends there from halfway into the elevator shaft, and whereby the cross beam is mounted and guided on vertical rails outside of the elevator shaft limited by two semicircles; whereby the carrying cables for the cross beam with the platform and for the at least one counterweight are arranged outside of the central elevator shaft.

This elevator system will be presented and described more in detail by means of the figures and the components as well as their functions will be explained. It is shown as follows:

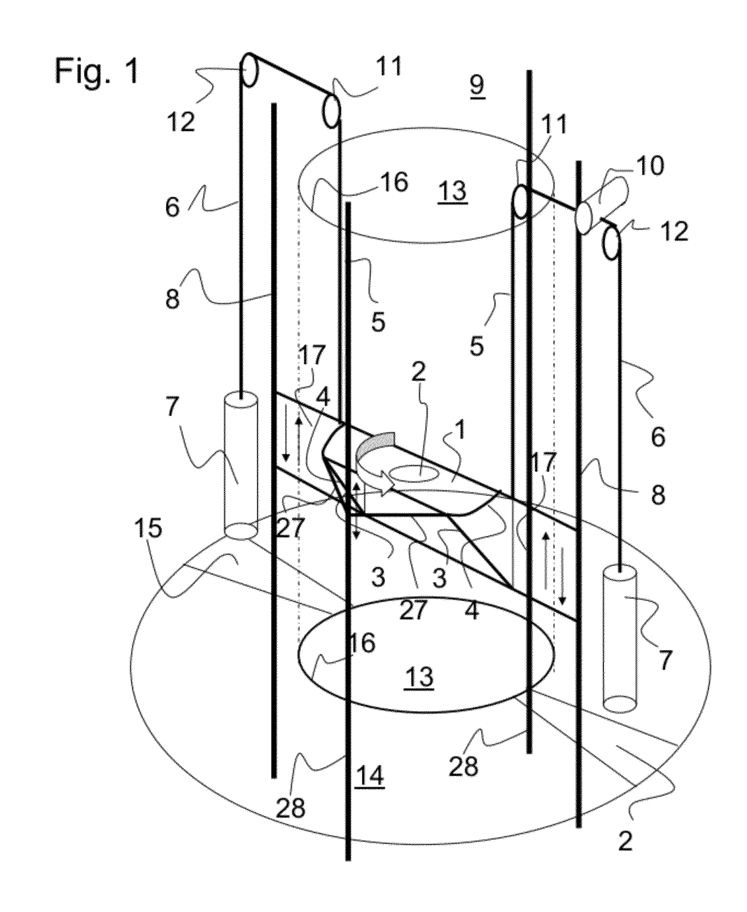

FIG. 1: a schematic representation of one of the tow platforms of the elevator system with its driving device;

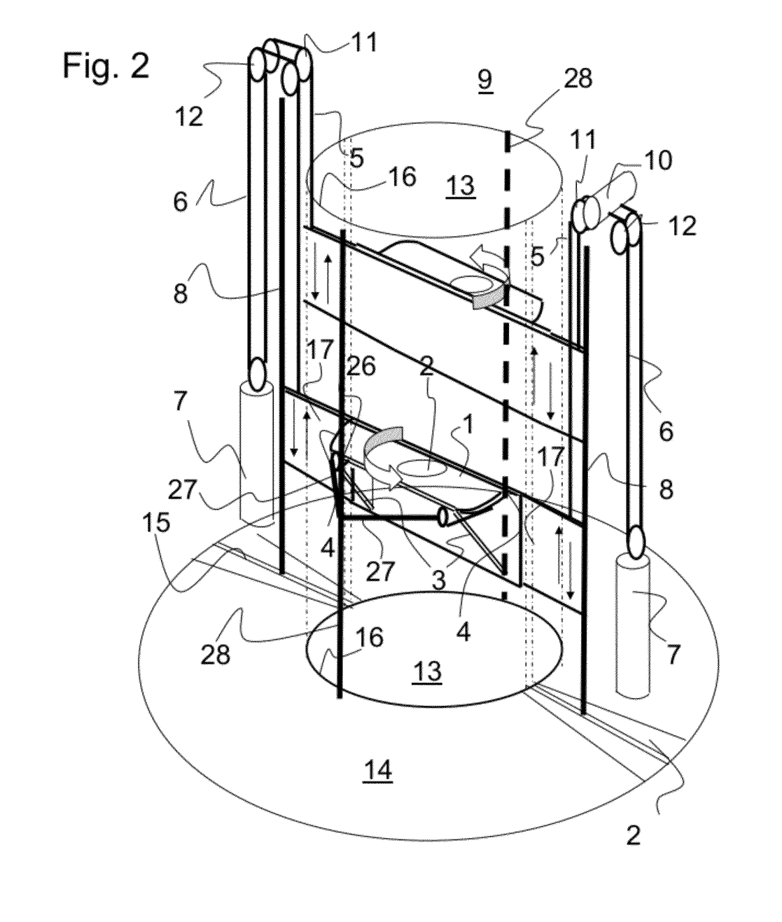

FIG. 2: a schematic representation as described in FIG. 1 but with two platforms and two elevators having each a common counterweight on both sides;

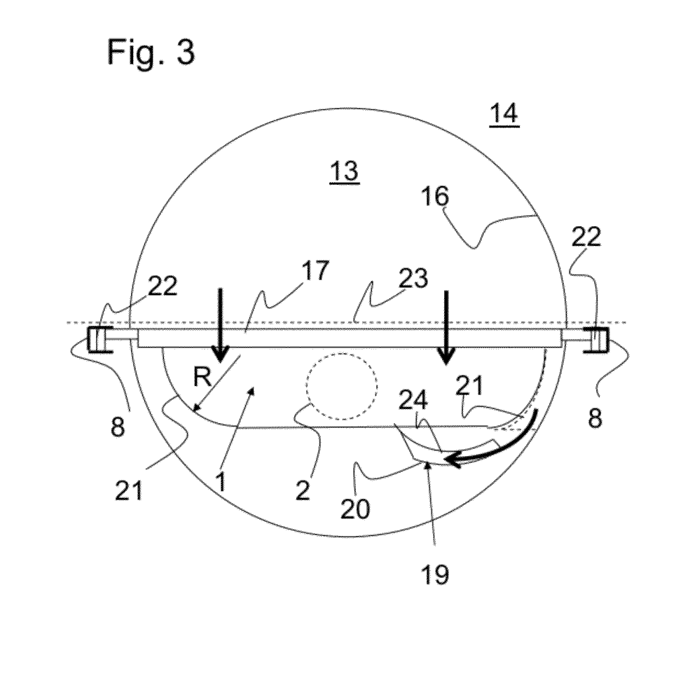

FIG. 3: an individual elevator platform with cross beams, a rotary disc and an end piece which can be pivoted in the elevator shaft seen from above;

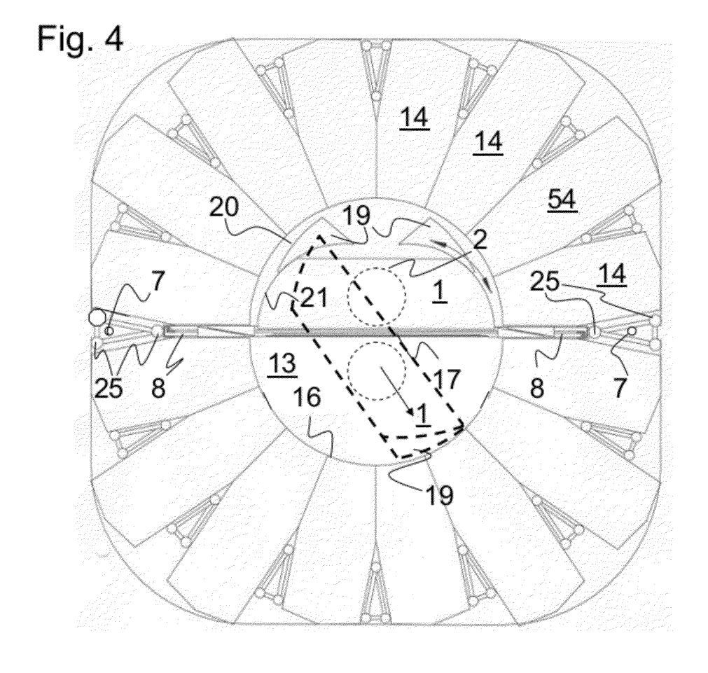

FIG. 4: the elevator represented in a plan view with the end pieces of the platforms which can be pivoted and the platforms themselves as well as with the parking spaces of a parking deck;

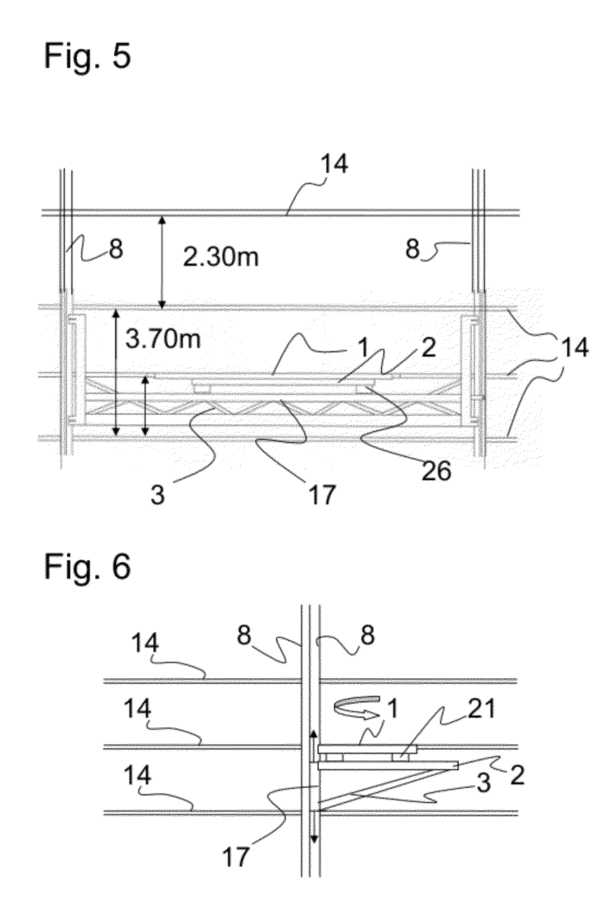

FIG. 5: an elevator platform in a vertical section with three parking decks in a side view;

FIG. 6: a section through several parking surfaces with an elevator platform.

FIG. 1 shows the elevator system schematically represented, whereby only one of the two elevator platforms 1 is represented. The elevator system serves to lift up and rotate unmanned vehicles in a parking garage with a central elevator shaft 13 which are enveloped by two semi-circles and parking areas being arranged around the said elevator shaft at different parking floors, respectively, parking decks 14. Only one individual annular parking floor 14 is here represented but effectively several parking decks 14 of this type are arranged one above the other with a central hole serving as an elevator shaft, whereby the said parking decks can form different floor heights in that there are spaced differently from each other in order to park vehicles of different heights in the most place optimized manner. A sports car needs essentially less floor height than a delivery van. Thus, the individual parking floors can be designed, for example, with a maximal floor height of 1.50 m and others can have a height of 2.30 m or optionally higher. Two elevator platforms 1 which can be independently operated from each other are arranged in the central circular recess which serves as elevator shaft 13 according to this specific elevator system. For reasons of simplicity, FIG. 1 represents only one of these two elevator platforms which are arranged symmetrically to each other on both sides of a diametric line, i.e. the one which protrudes from the represented center of the elevator shaft 13 towards the observer. Each of these elevator platforms 1 is supported on an approximately diametric cross beam 17 extending over the elevator shaft 13 and protrudes there from laterally hallway into the elevator shaft 13. The cross beam 17 which belongs to the elevator platform 1 realizes here altogether a rectangle construction with inner struts, a box-frame construction or a skeleton frame construction. The elevator platform 1 extends from the upper edge of the cross beam 17 to the side of the elevator shaft 13 positioned in the direction of the observer. The other cross beam arranged symmetrically thereto and its elevator platform extending backwards are not represented here. The elevator platform 1 is supported on the lower edge of the cross beam 17 by means of the bars 3 in order to obtain bearing capacity. The cross beam 17 extends longitudinally beyond the elevator shaft 13 and is mounted and guided on its vertical extending end edges, each in one rail 8. The weight of the elevator platform 1 and of a vehicle parked on the said elevator platform generates on an upper edge of the cross beam a force which is directed from the edge of the cross beam to the elevator platform 1; whereby a force acts on the lower edge of the cross beam via the bars 3; the said force being directed from the lower edge of the cross beam directly in the opposite direction (torque). These forces are transmitted by steel rolls to the rail 8 on which these steel rolls are rolling. A central rail 28 can be arranged each time between the two rails 8 on the periphery of the elevator shaft 13 and then the elevator platform is supported via the bars 27 and supported on the elevator platform by means of steel rolls. Thus, an extra stability is obtained for the elevator platform 1. The cross beam 17 and the elevator platform 1 mounted on the said cross beam are maintained by the carrying cables 5. These carrying cables are guided above the uppermost parking plan 9 around a cable disc 11 and run outwards from the elevator shaft 13. A further cable disc 12 is situated a little bit outwards around which the cable is guided downwards and acts as a carrying cable 6 for the counterweight 7. The driving motor 10 can be installed in the upper part or between the cable disc 12 and the counterweight 7. Advantageously, a gearless external rotor is employed as the driving motor. The carrying cables 5, 6 must run totally synchron on both sides of the elevator shaft 13 and can be driven solely by one motor in case of a corresponding cable guide, or each driven by its own motor; whereby these motors must run exactly synchron. It is important to consider that all the carrying cables 6 and their driving device including the counterweight 7 are situated outside the elevator shaft 13 in recesses 15 which extend vertically through all the parking decks 14 and the counterweights 7 running up and down in the said recesses. The cross beams 17 and the platforms 1 laterally mounted on the said cross beams so as to be pivoted, are situated exclusively in the elevator shaft 13. These two cross beams 17 and platforms 1 can run up and down totally independently from each other and the platforms 1 can also be pivoted independently from each other. For this purpose, the said platforms rest on a rotary disc 2 which can be driven and on which the elevator platform 1 can be pivoted around the vertical axis on both sides at 180° into this side of the elevator shaft; the said vertical axis protruding from the cross beam 17 into the said side. What is only to consider is that the platforms 1 are only allowed to cross when the platform 1 extends parallel to the cross beam 17. If a platform 1 has just been pivoted and therefore one of its halves protrudes with its cross beam 17 in the elevator space of the second platform 1, then you have to wait a moment until the second platform passes vertically and until the first platform 1 is again pivoted parallel with regard to the cross beam 17 and runs on the corresponding side of the elevator shaft; the cross beam being first able to cross this platform 1 on its way up or on its way down. This condition for the crossing of the platforms 1 is controlled and ensured by a central computer. In case the platform 1 of the first elevator is parallel to the cross beam 17, then the second platform can be operated completely without restrictions. Therefore, this elevator system comprises a further redundancy in case an elevator fails for any reason.

The FIG. 2 shows the same view but with two elevator platforms 1, each having a common counterweight 7. The two elevator systems could be also equipped with independent counterweight 7 either on both sides or it could be equipped only on one side with one elevator system having corresponding carrying cables 6 on both sides of the cross beam 17 for the individual counterweight 7 on one side. The two telescopic linear bearings 26 will also be shown in the following and the rotary disc 2 is mounted on the said linear bearings and whereon the elevator platform 1 is fixed. It is also shown that the two halves of the semi-circles are separated and arranged at a small distance from each other in order to create space for the elevator guiding rails 8 and the two cross beams 17. One of the central guiding rails 28 is seen on the front while the central rear guiding rail 28 is represented by dash lines. The elevator platform 1 is supported on these guiding rails 28 via the bars 27 and is roll-guided on the guiding rails 28 ensuring the platform 1 a better stability in that each platform 1 is permanently guided on three rails 8, 28.

The FIG. 3 shows an individual elevator platform 1 having a cross beam 17, a rotary disc 2 and an end piece 19 able to be pivoted, with a wedge and curved form in the elevator shaft 13 seen from above. As seen, the cross beam 17 extends on both sides beyond the inner edge 16 of the parking deck 14 and is also suspended on carrying cables outside the elevator shaft 13. The elevator platform 1 which is mounted on a telescopic linear axis 26 (FIG. 2) as well as on a rotary disc 2, extends laterally from the cross beam 7. This rotary disc 2 makes it possible to pivot the elevator platform 1 with regard to the cross beam 17 around the vertical axis. This pivoting can be realized by hydraulic, pneumatic or by means of an electro motor. The end sides 21 of the elevator platform 1 are rounded with a determined radius R. The elevator platform 1 is mounted slightly offset with respect to this diametric line 23. The cross beam extends directly near a diametric line 23 and the cross beam extends beyond this diametric line 23 and is parallel to the said diametric line for the second elevator platform. The end pieces 19 are hinged on the outer side of the elevator platform; whereby FIG. 3 shows only one of the two end pieces 19. This end piece 19 presents an inner edge 24, the curvature of which corresponds to the radius R of the outer edge 21 of the end side of the elevator platform 1. The end piece 19 can thus be pivoted with its inner edge along the outer edge 21 of the end of the elevator platform 1. For this purpose, an articulated mechanism is used which guides the end piece 19 correspondingly around the common center of these two circular curvatures. The two edges 21, 24 can also be designed in that one edge is directly guided force-fit to the other edge with regard to shear forces so that the two edges 21, 24 form together a notch-spring connexion. Thus, rolls having a smaller diameter and high weights can roll over this connexion without any problem. The outer edge 20 of the end piece 19 can be adapted in front of the end of the elevator platform 1 at the contour of the inner edge 16 of the parking deck 14 when the end piece 19 is completely pivoted. This edge 20 is thus wedged with the inner edge 16 of the parking deck. The result is also a connexion by means of a shear force fit so that a vehicle is able to roll over this connexion without compromising the stability of the said connection. With a second end piece 19 of this type on the opposite side of the elevator platform 1, the said side can be connected and locked on both sides with the plates of the parking deck 14.

A robot is mounted on the elevator platform 1, in its longitudinal direction, said robot presenting a rail extending in the longitudinal direction with lateral arms which can be deployed like scissors. The rail can be deployed telescopically in the longitudinal direction and pass under a vehicle which is on a parking deck and then slightly lift up the vehicle with its four wheels by means of the laterally deployable arms. Subsequently, the vehicle rolls on steel rolls associated to the robot at the ends of each deployable. The vehicle can be pulled on these steel rolls with the central rails on the elevator platform 1. When the vehicle arrives on the said platform, it is lifted to the calculated parking floor in lifting the elevator platform 1, on which floor the computer calculates the corresponding parking area. This parking area is situated in one of the two semi-circles and can extend in another direction compared to the cross beam 17. For this purpose, the elevator platform 1 must be pivoted by means of the rotary disc 2 to the center of the corresponding semi-circles and in the correct direction. This lateral movement and rotation around the vertical axis can occur as the elevator platform is lifted so that the lifting and pivoting movement of the elevator platform 1 are superposed and thus use the lifting time in order to pivot. As soon as the elevator platform is arrived on the right floor, the end pieces 19 are pivoted in front of the ends of the elevator platform 1 and are wedged with the inner edge 16 of the parking deck 14. When this wedging is finished, the robot can push the vehicle from the elevator platform 1 to the parking area which has been predetermined by the computer, replace the said vehicle on its wheels and the robot returns to the elevator platform 1. The end pieces 19 are then unlocked and the elevator platform comes back in the parallel position with regard to the cross beam 17 in that it is pivoting and is brought downwards to the initial state in order to pick up a new vehicle. The picking up of a parked vehicle from any determined parking area to any parking deck is realized in the exactly opposite order.

The FIG. 4 shows this elevator inside a parking garage concretely planned with measures; the parking areas being radially arranged in the plan view. The diameter of the elevator shaft is, for example, 8.50 m and the parking areas have different lengths. Because the parking garage is essentially a rectangular “plan view”—i.e. with rounded corners-, then the parking areas directed towards the corners of the rectangle present the longest size with about 6 m in length. They have a width of 2.20 m. Correspondingly, they can be used for particularly large and long vehicles while vehicles of smaller size can be parked if possible on shorter parking areas. These parking areas have also a smaller width, i.e. only 2.13 m. The supporting pillars 25 for the elevator are arranged outside the elevator shaft 13 and the counterweights 7 are arranged each in a free segment of a semi-circle extending along the cross beams 17. The cross beams 17 have then a length of 10.70 m and project over the elevator shaft 13 on both sides on 1.10 m. These two cross beams 17 for the two elevator platforms 1 have a width of about 0.40 m and are guided on rails 8 which extend along the supporting pillars 25. A platform 1 is represented in dash lines to show a state in which the platform 1 is pivoted on the shown example about 70° with regard to the cross beam 17 to service the oppositely disposed parking areas. In order to create a continuous driving surface, an end piece 19 is pivoted in front of the end side of the elevator platform 1 on the side which is pivoted toward the inner edge 16 as this is represented. A stable wedge with the parking deck is thus obtained and a sufficient stability in order to run with a vehicle as the rolls of the robot on which the vehicle is pushed on the parking areas support only small irregularities. The platform 1 is free on the other end or can also be wedged with a second end piece 19 and this is necessary to transfer the vehicles in the driving direction. A covered transition to the plates of the parking deck 14 can be guaranteed on both sides of the elevator platform 1 by the form of the end pieces, i.e. in that the installation has been separated in two halves and because the insertion of the diameter of the elevator's shaft, here 40 cm, is different according to each position during the rotation of the elevator platform 1.

The FIG. 5 shows the elevator platforms seen laterally. The rotary disc 2 has, for example, a diameter of 2.20 m. The floor's heights vary here from 1.60 m to 2.30 m. The cross beam 17 is 1.60 m high and is equipped several times with bars 3 in its inner side and has a total length of 10.70 m. The said cross beam is guided laterally on the guiding rails 8.

The FIG. 6 represents the elevator platform according to FIG. 5 viewed from the left. The rotary disc 2 is shown here under the elevator platform 1 as well as the supporting bars 3 for the construction of the platform; the said construction supporting the platform 1 and its weight on the cross beam 17. Further, the two lateral guiding rails 8 for the two platforms 1 can also be seen; the said two platforms can be operated independently from each other and from which only one is here represented.

1. Elevator system for vehicles in a parking garage with a central elevator shaft (13) and parking areas (14) arranged around the said elevator shaft, each floor having a central and circular inner edge (16) connected to the elevator shaft (15), characterized in that two elevators are arranged in the elevator shaft which can be operated independently of each other; each elevator platform being supported on an approximately diametric cross beam (17) extending over the elevator shaft (13) and the platform (1) extends therefrom halfway into the elevator shaft (13) and whereby The cross beam (17) is mounted and guided on vertical rails (8, 28) outside of the elevator shaft (13) limited by two semicircles; whereby the carrying cables (6) for the cross beam (17) having the platform (19) and for the counterweight (7) are arranged outside of the central elevator shaft (13).

2. Elevator system for vehicles according to claim 1, characterized in that each elevator platform (1) is positioned on a rotary disc and is motor driven on the said rotary disc above the cross beam (17) so as to be pivotable.

3. Elevator system for vehicles according to any of the preceding claims, characterized in that each elevator platform (1) can be moved laterally with tow linear bearings into the center of the circle or semi-circle of the assessed vehicle park halves.

4. Elevator system for vehicles according to any of the preceding claims, characterized in that each elevator platform (1) is supported on a rotary disc (2) and is motor driven on the said rotary disc above the cross beam (17) so as to be pivotable, and in that the two end sides (18) of the elevator platform (1) are wedged in pivoting an end piece (19) with the closest circular inner edge (16) of the parking area on each parking floor so that the elevator platform (1) forms on both sides a plan continuous surface with the parking area (14) and the two end pieces (19) and is tightly connected so that the change of the weight on the elevator platform (1) can be supported by the parking areas (14).

5. Elevator system for vehicles according to claim 4, characterized in that the edges (21) on the end side of the elevator platforms (1) extend circularly and the end pieces (19) present a circular edge with the same Radius R on each side facing these edges (21) on the end side, so that the said end pieces can be driven along these edges (21) on the end side in front of the ends of the elevator platforms (1);
whereby their opposite edges (20) present such a contour so that the said edges terminate in a flushing manner with the inner edge (16) of the parking area (14) when moved in front of the elevator platforms (1).

6. Elevator system for vehicles according to claim 5, characterized in that the end pieces (19) which must terminate in a flushing manner with the elevator platforms (1) and the inner edges (16) of the parking areas (14) present an edge of the type which can be wedged with the edges (16) to be connected of the elevator platforms (1) and the parking areas (14).

7. Elevator system for vehicles according to any of the preceding claims, characterized in that each cross beam (17) is longer than the diameter of the elevator shaft (13) and extends through the said elevator shaft almost in a diametric manner and in that this cross beam (17) is supported on a vertical rail (8) on both sides, on the top and at the bottom over each Roll (22) as well as supported by cross bearings (27) and guided by roller bearings laterally on a central rail (28), on the periphery of the elevator shaft (13).

8. Elevator system for vehicles according to any of the preceding claims, characterized in that the end pieces (19) are mechanically guided on the edges (21) of the platforms on the end side with their edges (24) facing the platforms (1).

9. Elevator system for vehicles according to any of the preceding claims, characterized in that the end pieces (19) are pivotably connected with the platforms (1) by mechanic supporting and steering shafts and can pivoted pneumatically, hydraulically or by an electro motor in front of the end sides (18) of the platforms (1) and which can be pivoted in the opposite direction of the end sides (18).

10. Elevator system for vehicles according to any of the preceding claims, characterized in that each elevator platform (1) is driven by its own driving device (10) and in that the two elevator platforms (1) can be operated independently of each other which is guaranteed by means of an electronic unit that the car can cross only when the platforms (1) are in the initial condition, e.g. extend parallel to the cross beam (17).
